(19) United States
(12) Patent Application Publication
(10) Pub. No.: US 2026/0233584 A1
(43) Pub. Date: Aug. 13, 2026

(54) AIR VENT ASSEMBLY HAVING OSCILLATING AIRFLOW

(71) Applicant: GM GLOBAL TECHNOLOGY OPERATIONS LLC, Detroit, MI (US)

(72) Inventors: Minhyung Kang, Bucheon-si (KR); Donghyun Kim, Seoul (KR); Keunhyeong Ryu, Bupyeong-gu (KR); Dongheon Lee, Dobong-gu (KR); Gyuseok Jeong, Gyeonggi-do (KR); Juyup Seok, Seoul (KR)

(73) Assignee: GM GLOBAL TECHNOLOGY OPERATIONS LLC, Detroit, MI (US)

(21) Appl. No.: 19/047,918

(22) Filed: Feb. 7, 2025

(51) Int. Cl. B60H 1/34

(52) U.S. Cl. CPC B60H 1/3428; B60H 2001/3471

(57) ABSTRACT

An air vent assembly includes a fixture having a vehicle mounting portion, an air collector rotatably attached to the fixture about a longitudinal axis having a nozzle with an inlet and an outlet, and a vent pivotably attached to the air collector about a pivot axis that extends through the nozzle and the vent. The assembly also includes an actuation body at least partially surrounding the vent and moveable between a first axial position preventing pivotable movement of the vent relative to the air collector about the pivot axis and a second axial position allowing pivotable movement of the vent relative to the air collector about the pivot axis.

### BACKGROUND

The present disclosure relates to an air vent assembly, and more particularly, to an air vent assembly incorporated into a vehicle.

Passenger vehicles generally into a heating, ventilation, and air conditioning (HVAC) system. The HVAC system manages a temperature of air circulating through the vehicle. The HVAC system can provide heating or cooling to maintain a passenger cabin in the vehicle at a desired temperature. The HVAC system may use multiple outlet vents that can be positioned to direct the air from the HVAC in a desired direction into the passenger cabin.

### SUMMARY

Disclosed herein is an air vent assembly. The assembly includes a fixture having a vehicle mounting portion, an air collector rotatably attached to the fixture about a longitudinal axis having a nozzle with an inlet and an outlet, and a vent pivotably attached to the air collector about a pivot axis that extends through the nozzle and the vent. The assembly also includes an actuation body at least partially surrounding the vent and moveable between a first axial position preventing pivotable movement of the vent relative to the air collector about the pivot axis and a second axial position allowing pivotable movement of the vent relative to the air collector about the pivot axis.

In one aspect of the disclosure the vent includes a pair of opposing projections located within a pair of corresponding receptacles in the air collector and the pair of projections and the pair of corresponding receptacles are at least partially located along the pivot axis.

In one aspect of the disclosure the actuation body is moveable axially relative to the air collector along the longitudinal axis between the first axial position and the second axial position.

In one aspect of the disclosure the vent includes a first pair of centering projections that engage a locking projection on the actuation body when the actuation body is in the first axial position.

In one aspect of the disclosure one of the air collector and the actuation body includes a position retainer for engaging one of a pair of recesses in the other of the air collector and the actuation body when the actuation body is in the first axial position and the other of the pair of recesses when the actuation body is in the second axial position.

In one aspect of the disclosure one of the air collector and the actuation body includes a separation prevention projection for engaging a slot in the other of the air collector and the actuation body and the slot includes a length extending in a direction parallel to the longitudinal axis.

In one aspect of the disclosure the assembly includes at least one blade configured to direct an airflow through an outlet of the air vent assembly.

In one aspect of the disclosure the at least one blade includes a pair of blades at least partially supported by the actuation body on a first axial side and a blade cover plate on a second axial side.

In one aspect of the disclosure the vent at least partially overlaps the air collector and the pivot axis is located within 5 mm of the outlet of the nozzle relative to the longitudinal axis.

In one aspect of the disclosure the vent at least partially overlaps the air collector and the pivot axis is located between 2 mm and 3 mm of the outlet of the nozzle relative to the longitudinal axis.

In one aspect of the disclosure the air collector includes a perimeter wall surrounding the nozzle and the inlet of the nozzle includes a circular cross-sectional area and the outlet of the nozzle includes a non-circular cross-sectional area.

In one aspect of the disclosure an outlet of the vent and the outlet of the nozzle are each symmetric about two separate planes and each of the two separate planes extend through and are parallel to the longitudinal axis.

In one aspect of the disclosure the pivot axis extends through a first one of the two separate planes and a second one of the two separate planes is perpendicular to the first one.

In one aspect of the disclosure the pivot axis intersects the longitudinal axis.

In one aspect of the disclosure an intersection of the vent and the air collector includes a metallic component.

Disclosed herein is a method of operating an air vent assembly. The method includes directing an airflow through the air vent assembly. The air vent assembly includes a fixture having a vehicle mounting portion, an air collector rotatably attached to the fixture about a longitudinal axis having a nozzle with an inlet and an outlet, and a vent pivotably attached to the air collector about a pivot axis that extends through the nozzle and the vent. The assembly also includes an actuation body at least partially surrounding the vent and moveable between a first axial position preventing pivotable movement of the vent relative to the air collector about the pivot axis and a second axial position allowing pivotable movement of the vent relative to the air collector about the pivot axis. The method also includes positioning the actuation body in one of the first axial position or the second axial position to control oscillating movement of the vent.

In one aspect of the disclosure the method includes rotating the air collector and the actuation body relative to the fixture.

In one aspect of the disclosure the air vent assembly includes a plurality of blades that are pivotable relative to the actuation body.

Disclosed herein is a vehicle. The vehicle includes a passenger cabin supported by wheels, a blower motor configured to create a flow of air within a duct assembly, and an air vent assembly including communication with the duct assembly. The air vent assembly includes a fixture having a vehicle mounting portion, an air collector rotatably attached to the fixture about a longitudinal axis having a nozzle with an inlet and an outlet, and a vent pivotably attached to the air collector about a pivot axis that extends through the nozzle and the vent. The assembly also includes an actuation body at least partially surrounding the vent and moveable between a first axial position preventing pivotable movement of the vent relative to the air collector about the pivot axis and a second axial position allowing pivotable movement of the vent relative to the air collector about the pivot axis.

In one aspect of the disclosure the vent includes a first pair of centering projections that engage a locking projection on the actuation body when the actuation body is in the first axial position.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a schematic illustration of a vehicle with an air management system.

FIG. 2 is a schematic illustration of an exploded view of an air vent assembly from the air management system of FIG. 1.

FIG. 3 is a cross-sectional view of an air collector and a vent from FIG. 2.

FIG. 4 is a schematic illustration of the air vent assembly in a first rotational position.

FIG. 5 is a cross-sectional view along the air vent assembly.

FIG. 6 is a schematic illustration of the air vent assembly moveable between a first and second axial position.

FIG. 7 is a schematic illustration of the vent in an oscillating or pivoting position.

FIG. 8 is a schematic illustration of the vent in a fixed position.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

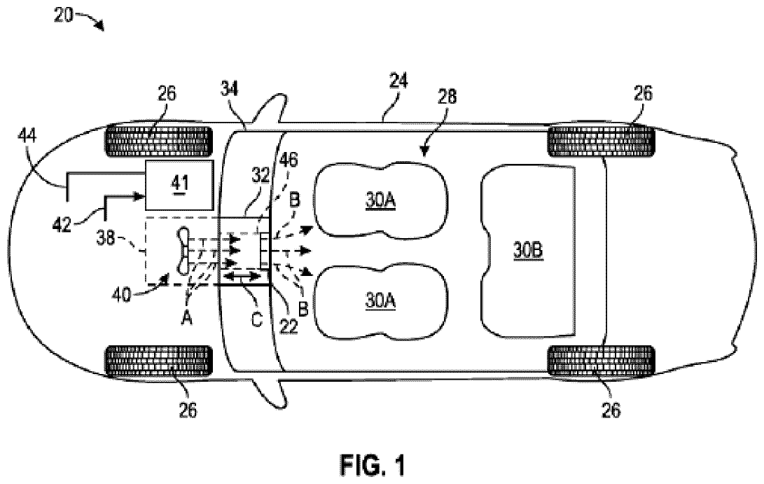

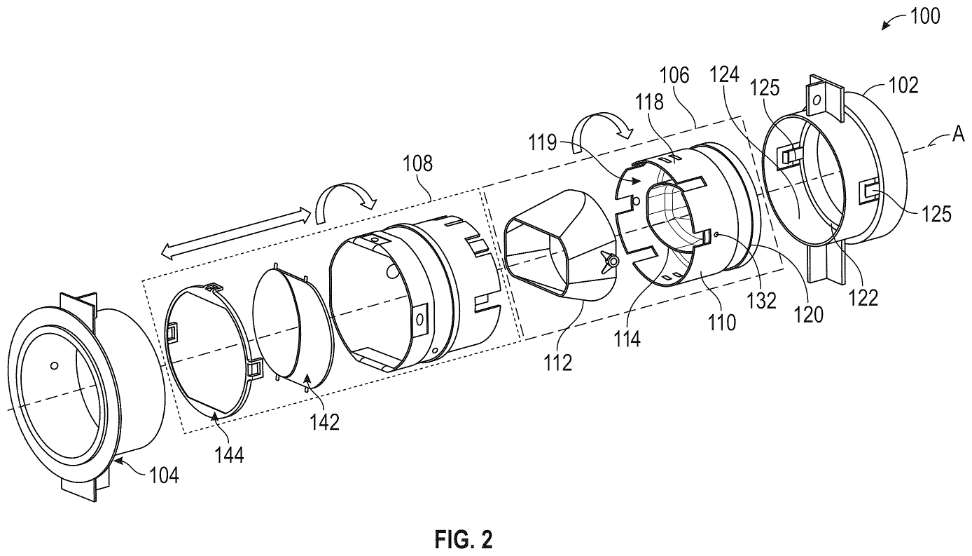

Referring to the drawings, wherein like reference numbers refer to the same or similar components throughout the several views, an example vehicle 20, such as a motor vehicle, is shown in FIG. 1 having an air vent assembly 100 as set forth herein. The vehicle 20 includes a body 24 positioned with respect to a set of wheels 26, with the body 24 defining an interior 28, i.e., a passenger compartment or cabin. Within the interior 28 is positioned at least one row of seats 30A, which is depicted in FIG. 1 as example respective first and second row of seats 30A, 30B. The first row of seats 30A may include respective driver-side and passenger-side seats as shown. Other seating configurations may be envisioned without departing from the intended inventive scope, including only the first row of seats 30A, bench-style seats or bucket seats in either row of seats and, or an additional row of seats (not shown). Example embodiments of the air vent 22 are depicted in FIGS. 2-8. It should be appreciated that the air vent 22 is not limited to being used in a vehicle 20, as the air vent assembly 100 may be used with other structures or devices, such as, but not limited to, buildings, watercraft, aircraft, electronic devices, and the like.

The air vent assembly 100 of FIG. 1 may be optionally positioned within a center stack 32 of the interior 28, adjacent to a dashboard 34. In other embodiments the air vent assembly 100 may be positioned anywhere along the dashboard 34; within a ceiling (not shown); within one or more pillars, i.e., an A-pillar, a B-pillar, and the like; with respect to the rear row of seats 30B, such as between the front row of seats 30A and the rear row of seats 30B and/or adjacent the rear row of seats 30B; and the like. For example, the rear row of seats 30B may be divided into separate seating areas by an arm rest (not shown) or other structure, with the air vent assembly 100 positioned within or adjacent to such structure.

The air vent assembly 100 is in communication with a heating, ventilation, and air conditioning (HVAC) system 38 having an air circulation device 40 with a blower motor, for instance a motor-driven fan or blower, and with a controller 41. The HVAC system 38 receives HVAC control setting signal (line 44) from the controller 41 in response to user-selected HVAC settings (arrow 42) from controls, such as buttons, knobs, and the like. In response to the received HVAC control setting signal (line 44), the HVAC system 38 circulates ambient, heated, or cooled air (arrows A) into the interior 28, for instance through a duct 46 and the air vent assembly 100. In embodiments in which the air vent assembly 100 is used in proximity to the rear row of seats 30B, the duct 46 may be extended beyond the front row of seats 30A such that the duct 46 supplies the air (arrows A) to the air vent assembly 100 wherever the air vent assembly 100 is positioned within the interior 28. The air is then directed from the air vent assembly 100, into the vehicle interior 28, in a desired direction (arrow B).

FIG. 2 illustrates an example of an air vent assembly 100. As shown in FIG. 2, the air vent assembly 100 includes a fixture 102 having a pair of flanges for securing relative to a first portion of the vehicle 20 and an outer body 104 for securing relative to another portion of the vehicle 20, such as the dashboard 34. In the illustrated example, the fixture 102 and the outer body 104 are spaced from each other along a central longitudinal axis A. The assembly 100 also includes a first portion 106 and a second portion 108 located along the axis A and between the fixture 102 and the outer body 104. In this disclosure, axial or axially, radial or radially, or circumference or circumferentially are with respect to the axis A unless stated otherwise. Similarly, an upstream or proximal end of the air vent assembly 100 and downstream or distal end of the air vent assembly 100 are with respect to the flow of air through the assembly 100 traveling from the fixture 102 towards the outer body 104.

In the illustrated example, the first portion 106 of the air vent assembly 100 assembly includes an air collector 110 and a vent 112 pivotably attached to the air collector 110. The air collector 110 includes a cylindrical radially outer wall 118 and a radially inner wall forming a nozzle 114. The nozzle 114 at least partially defines the air flow path through the air vent assembly 100 while the outer wall 118 is spaced from the nozzle 114. The radially outer wall 118 and the nozzle 114 are attached to each other adjacent to a proximal end of the air collector 110 and are formed as a unitary or single piece. A nozzle pivoting region 119 is located radially outward from the nozzle 114 and radially inward from the outer wall 118 to provide clearance for the nozzle 114 to pivot or oscillate at least partially within the nozzle pivoting region 119.

The air collector 110 allows the first and second portions 106 and 108 to rotate relative to the fixture 102 and the outer body 104. The ability to rotate the first and second portions 106 and 108 allows for the blades 142 on the second portion 108 to direct the air flow 365 degrees around the axis A. The air collector 110 remains fixed from moving in an axial direction along the axis A relative to the fixture 102 but can rotate about the axis A due to an interaction between a circumferential ledge 120 on a radially outer surface of outer wall 118 of the air collector 110 that is accepted against a circumferential ledge 122 defined by a radially inner surface 124 on the fixture 102. Retention flanges 125 on the fixture 102 include projections that abut the circumferential ledge 122 to allow the air collector 110 to rotate relative to the fixture 102 while still being fixed from moving axially.

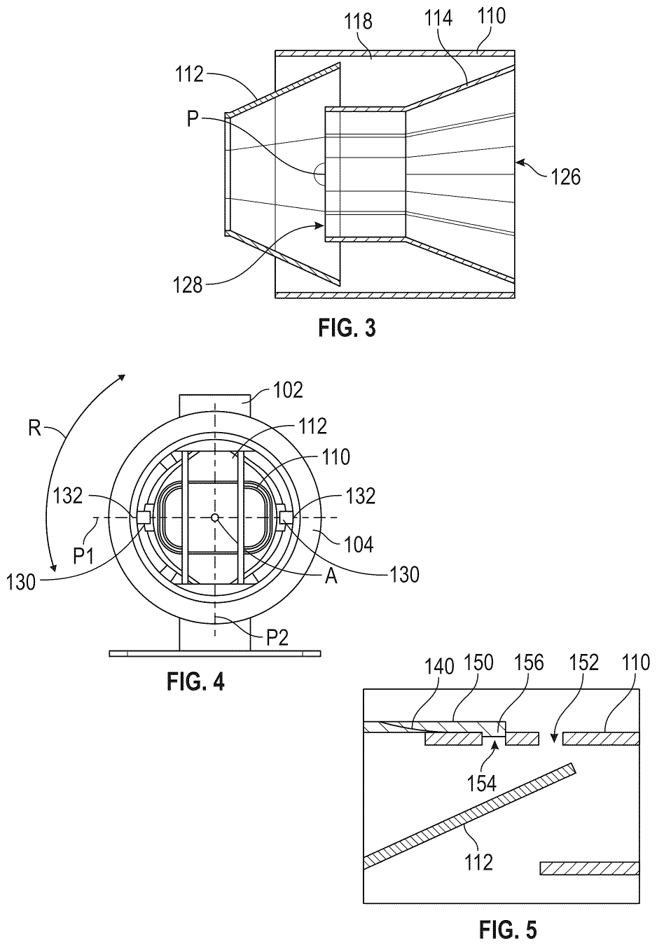

As shown in FIG. 3, the nozzle 114 includes an inlet 126 located at a proximal end of the air collector 110 and an outlet 128 located at a distal end of the nozzle 114. A cross-sectional area of the inlet 126 is greater than a cross-sectional area of the outlet 128. The inlet 126 can include a circular cross-section while the outlet 128 can include a non-circular or elliptical cross-section. One feature of the nozzle 114 including a cross-sectional area that reduces along the direction flow of the air therethrough, is an increase in air velocity as the air passes between the inlet 126 and the outlet 128.

The vent 112 is pivotably attached to the air collector 110 about a pivot axis P. As shown in FIG. 3, the pivot axis P extends through at least a portion of the outer wall 118, the vent 112, and the nozzle 114. The outlet 128 of the nozzle 114 and the outlet of the vent 112 each include a width in the direction of the pivot axis P and a height perpendicular to the pivot axis P. As shown in FIGS. 3-5, a height of the outlet 128 of the nozzle 114 is greater than the height of the outlet of the vent 112. Additionally, a ratio between the width of each of the outlet 128 of the nozzle 114 and the outlet of the vent 112 to their corresponding heights is between 1.5-2.5. Furthermore, the width of the outlet 128 of the nozzle 114 can be greater than the width of the outlet of the vent 112.

The vent 112 includes a pair of projection 130 (FIG. 4) that extend outward and are accepted within corresponding openings 132 (FIG. 2) in the air collector 110, such as in the outer wall 118. In one example, each of the projections 130 are metallic and each of the openings 132 are defined by a metallic bushing. One feature of the metallic projection and bushing is a reduction in wear and friction between the vent 112 and the air collector 110.

As shown in FIG. 3, the vent 112 is at least partially recessed into the distal end of the air collector 110, such that a proximal end of the vent 112 is surrounded by or axially aligned with the outer wall 118 and a distal end of the vent 112 is spaced axially from the distal end of the air collector 110. In the illustrated example, approximately 50% of an axial length of the vent 112 is surrounded by the outer wall 118. Furthermore, the axial overlap can be between the distal end of the nozzle 114 and the proximal end of the vent 112 can be between 2 and 12 mm (0.08 and 0.47 inches) or between 2 and 3 mm (0.08 and 0.12 inches). Additionally, an axial distance from the pivot axis P to the proximal end of the vent 112 can be between approximately 2.5 to 6.5 mm (0.10 and 0.26 inches). In this disclosure, approximately includes within ten percent of the identified value(s) unless stated otherwise.

In the illustrated example, the second portion 108 includes an actuation body 140, a pair of blades 142, and a blade cover plate 144. The pair of blades 142 are at least partially supported by the actuation body on a first axial side and the blade cover plate 144 on a second axial side. The actuation body 140 is moveable in an axial direction relative to the axis A and in a rotational direction in unison with the air collector 110 about the axis A relative to the fixture 102.

The axial movement of the actuation body 140 can allow the vent 112 to pivot about the axis P or be fixed from pivoting about the axis P. For example, when the actuation body 140 is in a first axial position closer to the air collector 110 as shown in FIG. 8, the vent 112 is prevented from pivoting or oscillating relative to the air collector 110. The vent 112 is prevented from pivoting when a locking projection 146 on the actuation body 140 is accepted between a pair of centering projections 148 located adjacent to the projection 130. In one example, the pair of centering projections 148 are spaced from each other by approximately 90 degrees relative to the pivot axis P. One feature of the centering projections 148 having this configuration is that the locking projection 146 can lock the vent 112 from oscillating even when the vent 112 already oscillating. Conversely, when the actuation body 140 is in a second axial position moved in a direction opposite the air collector 110 as shown in FIG. 7, the vent 112 is allowed to pivot or oscillate about the axis P relative to the air collector 110.

As shown in FIG. 5, a position guide 150 on the actuation body 140 is movable between a first recess 152 in the air collector 110 when in the first axial position and into a second recess 154 when in the second axial position. In the illustrated example, a distal end of the position guide 150 includes a projection 156 or hook that is at least partially accepted within one of the first or second recesses 152, 154 depending on the desired position for the actuation body 140.

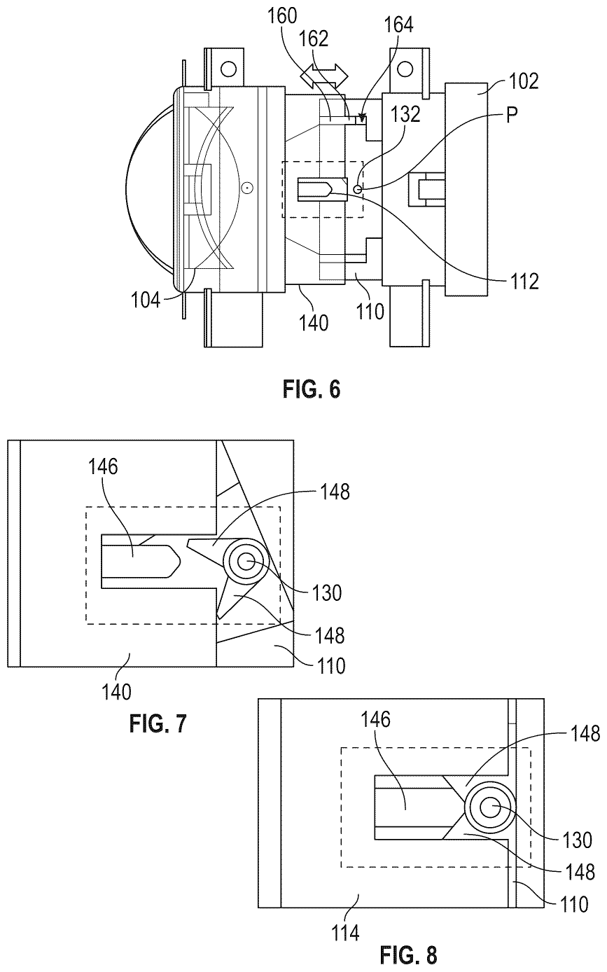

As shown in FIG. 6, the actuation body 140 also includes a separation retainer 160 that includes a projection 162 that travels through a separation guide opening 164 in the air collector 110. One feature of separation retainer 160 in the separation guide opening 164 is to prevent the actuation body 140 from separating from the air collector 110 when the actuation body 140 is moving between the first and second positions. Additionally, the projection 162 allows the actuation body 140 to transfer circumferential loads to the air collector 110 when rotating the actuation body 140 with the blades 142.

As shown in FIG. 4, the first and second portions 106 and 108 rotate relative to the fixture 102 and the outer body 104 as shown by arrow R. Additionally, in one example, the blades 142 can be pivoted to angles between zero and 30 degrees relative to the axis A to direct the airflow off the longitudinal axis of the air vent assembly 100. The vent 112 is also symmetric about a first plane and a second plane and each of the first and second planes extend through and are parallel to the longitudinal axis A. The pivot axis P also extends parallel through the first plane and the second plane is perpendicular to the first plane.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. An air vent assembly, comprising:
a fixture having a vehicle mounting portion;
an air collector rotatably attached to the fixture about a longitudinal axis, wherein the air collector includes a nozzle having an inlet and an outlet;
a vent pivotably attached to the air collector about a pivot axis that extends through the nozzle and the vent; and
an actuation body at least partially surrounding the vent and moveable between a first axial position preventing pivotable movement of the vent relative to the air collector about the pivot axis and a second axial position allowing pivotable movement of the vent relative to the air collector about the pivot axis.

2. The air vent assembly of claim 1, wherein the vent includes a pair of opposing projections located within a pair of corresponding receptacles in the air collector and the pair of projections and the pair of corresponding receptacles are at least partially located along the pivot axis.

3. The air vent assembly of claim 1, wherein the actuation body is moveable axially relative to the air collector along the longitudinal axis between the first axial position and the second axial position.

4. The air vent assembly of claim 3, wherein the vent includes a first pair of centering projections that engage a locking projection on the actuation body when the actuation body is in the first axial position.

5. The air vent assembly of claim 4, wherein one of the air collector and the actuation body includes a position retainer for engaging one of a pair of recesses in the other of the air collector and the actuation body when the actuation body is in the first axial position and the other of the pair of recesses when the actuation body is in the second axial position.

6. The air vent assembly of claim 5, wherein one of the air collector and the actuation body includes a separation prevention projection for engaging a slot in the other of the air collector and the actuation body and the slot includes a length extending in a direction parallel to the longitudinal axis.

7. The air vent assembly of claim 1, including at least one blade configured to a direct an airflow through an outlet of the air vent assembly.

8. The air vent assembly of claim 7, wherein the at least one blade includes a pair of blades at least partially supported by the actuation body on a first axial side and a blade cover plate on a second axial side.

9. The air vent assembly of claim 1, wherein the vent at least partially overlaps the air collector and the pivot axis is located within 5 mm of the outlet of the nozzle relative to the longitudinal axis.

10. The air vent assembly of claim 1, wherein the vent at least partially overlaps the air collector and the pivot axis is located between 2 mm and 3 mm of the outlet of the nozzle relative to the longitudinal axis.

11. The air vent assembly of claim 1, wherein the air collector includes a perimeter wall surrounding the nozzle and the inlet of the nozzle includes a circular cross-sectional area and the outlet of the nozzle includes a non-circular cross-sectional area.

12. The air vent assembly of claim 1, wherein an outlet of the vent and the outlet of the nozzle are each symmetric about two separate planes and each of the two separate planes extend through and are parallel to the longitudinal axis.

13. The air vent assembly of claim 12, wherein the pivot axis extends through a first one of the two separate planes and a second one of the two separate planes is perpendicular to the first one.

14. The air vent assembly of claim 1, wherein the pivot axis intersects the longitudinal axis.

15. The air vent assembly of claim 1, wherein an intersection of the vent and the air collector includes a metallic component.

16. A method of operating an air vent assembly, the method comprising:
directing an airflow through the air vent assembly, wherein the air vent assembly includes:
a fixture having a vehicle mounting portion;
an air collector rotatably attached to the fixture about a longitudinal axis, wherein the air collector includes a nozzle having an inlet and an outlet;
a vent pivotably attached to the air collector about a pivot axis that extends through the nozzle and the vent; and
an actuation body at least partially surrounding the vent and moveable between a first axial position preventing pivotable movement of the vent relative to the air collector about the pivot axis and a second axial position allowing pivotable movement of the vent relative to the air collector about the pivot axis; and
positioning the actuation body in one of the first axial position or the second axial position to control oscillating movement of the vent.

17. The method of claim 16, including rotating the air collector and the actuation body relative to the fixture.

18. The method of claim 17, wherein the air vent assembly includes a plurality of blades that are pivotable relative to the actuation body.

19. A vehicle comprising:
a passenger cabin supported by a plurality of wheels;
a blower motor configured to create a flow of air within a duct assembly; and
an air vent assembly including communication with the duct assembly, wherein the air vent assembly includes:
a fixture having a vehicle mounting portion;
an air collector rotatably attached to the fixture about a longitudinal axis, wherein the air collector includes a nozzle having an inlet and an outlet;
a vent pivotably attached to the air collector about a pivot axis that extends through the nozzle and the vent; and
an actuation body at least partially surrounding the vent and moveable between a first axial position preventing pivotable movement of the vent relative to the air collector about the pivot axis and a second axial position allowing pivotable movement of the vent relative to the air collector about the pivot axis.

20. The vehicle of claim 19, wherein the vent includes a first pair of centering projections that engage a locking projection on the actuation body when the actuation body is in the first axial position.
